(19) United States
(12) Patent Application Publication
(10) Pub. No.: US 2006/0236308 A1
(43) Pub. Date: Oct. 19, 2006

(54) Configurable functionality chaining

(76) Inventors: James A. Lamb, Elkhorn, NE (US); Joseph G. Giebler, Omaha, NE (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/109,218

(22) Filed: Apr. 18, 2005

(51) Int. Cl. G06F 9/44

(52) U.S. Cl. 717/121

(57) ABSTRACT

Systems, methods, and devices are provided for configurable functionality chaining. One computing device embodiment includes a client layer, a functionality layer, and a data store layer. The client layer receives a client instruction from at least one of a number of clients. The functionality layer having an application program interface (API) interprets the client instruction and selects a number of functionality modules to form a functionality chain for use in accomplishing the client instruction. The data store layer stores data for use by the number of functionality modules.

### BACKGROUND

Application programs on a client have been constructed generally to communicate a client instruction, for a network functionality to be performed, to a network device. The client instruction contained the details for initiating and, in some instances, controlling the network functionality. The client instruction was formed based upon computer executable instructions typically within the application program.

In such cases, the application program had to maintain an updated knowledge of the set of network functionalities available and the actions used to fulfill the client instruction. This information formed the basis for correctly carrying out the client instruction.

When information was received from multiple clients, the application program on each client would have such information in its application program. Accordingly, when a change was to be made to the functionalities provided (e.g., adding or removing of a functionality), each application program would have to be modified on each client in order to accomplish a particular client instruction effectively and uniformly from the multiple clients. Further, when clients have different operating systems, application programs, and/or different transport mechanisms, the application programs would be limited to use of functionalities provided in the application programs, although other functionalities may have been available on the network.

In some cases, an application program may have used a number of functionalities to accomplish a client instruction. In such cases, the instructions for initiating the various functions were part of the application program and typically part of the client instructions.

Accordingly, in order to change the order of functions or to add or remove functions, each such application program on each client would have to be modified. In this manner, the changing of functionalities for use by a client was cumbersome and the number of changes provided many opportunities for errors in correctly executing the functionalities and in keeping the application programs on the number of clients updated, among other issues.

### BRIEF DESCRIPTION OF THE DRAWINGS

FIG. 1 is a block diagram of a computing system embodiment.

FIG. 2 illustrates an example of the embodiment of FIG. 1 configured for a particular set of functionalities.

FIG. 3A illustrates an example of the embodiment of FIG. 1 configured for another particular set of functionalities.

FIG. 3B illustrates an example of a partitioning functionality, in accordance with an embodiment.

FIG. 4 illustrates an example of the embodiment of FIG. 1 configured for another particular set of functionalities.

### DETAILED DESCRIPTION

The present disclosure includes a number of device, system, and method embodiments that include configurable functionality chaining, among other features. For example, various computing devices include a client layer, a functionality layer, and a data store layer. The client layer receives a client instruction from at least one of a number of clients. The functionality layer interprets the client instruction and selects a number of functionality modules to form a functionality chain for use in accomplishing the client instruction. This can be accomplished through use of an application program interface (API), for example. The data store layer stores data for use by the number of functionality modules.

As the reader will appreciate, embodiments of the present disclosure can be utilized with various transport mechanisms. For example, common object request broker architecture (CORBA), remote procedure call (RPC), socket, Java messaging service (JMS), and Tuxedo are examples of different transport mechanisms for passing information between software components.

The client, functionality, and/or data store layers can utilize object technology which is a methodology for designing and programming. In object technology, implemented using object oriented programming, systems are designed with building blocks that can contain both the data and the processing, (e.g., the “attributes” and the “methods”, as the same will be recognized by those in the art). C++ and Java are examples of object oriented programming languages. Similarly, the description of an object's data content and its relation to other objects can be described in Extensible Markup Language (XML), for example.

Object oriented programming is a form of modular programming with rules that allow sets of computer executable instructions to be bundled so that they can be more easily reused and interchanged between programs. Major concepts of object orient programming include encapsulation, inheritance and dependencies. Encapsulation is the creation of self-sufficient modules that contain the data and the processing, e.g., attributes (data structures) and methods (functions), that manipulate that data.

These encapsulated, abstract data types are called “object classes.” A particular set of attributes (data structures) and methods (functions) within an object class are referred to as an instance. For example, in a payroll system, a class could be defined as Manager, and each manager (e.g., Pat and Jan), the actual objects, are instances of that class. Classes are created in hierarchies, and inheritance allows the knowledge in one class to be passed through the hierarchy.

That means less programming is required when adding functions to complex systems. For example, if a step is added at the bottom of a hierarchy, then only the processing and data associated with that unique step needs to be added. Everything else about that step is inherited by the other classes. Dependencies between classes refer one class using the attributes (data structures) and methods (functions) of another class.

In various computing system and device embodiments, the computing device can have a number of APIs that can be used to accomplish the client instruction. APIs can also implement the functionalities and/or can be used to accomplish the chaining of the functionalities together. In some embodiments, a single API can be used to accomplish one or more of these processes.

An API can include a number of functionality module configurations for forming the functionality chain. For example, the API can include instructions to identify a particular functionality module configuration to utilize. Some examples of functionality modules are provide below, in more detail. In some embodiments, an API can include instructions to initiate functionality modules in accordance with the particular functionality module configuration identified.

In various computing system embodiments, the computing system can include a number of computing devices, each having access to a number of functionality modules for accomplishing a client instruction. A computing device can be designed to receive a client instruction from at least one of a number of clients, configure a number of functionality modules to form a functionality chain for use in accomplishing the client instruction, and access data, for use by the number of functionality modules, from a number of data stores. In various embodiments, the ability to configure the number of functionality modules into a functionality chain can be accomplished dynamically, for example, at runtime of the application program, at runtime of the client instruction, or at runtime of an API that interprets the client instruction and/or selects the functionality modules, among other times during the accomplishment of the client instruction.

A Computing System Example

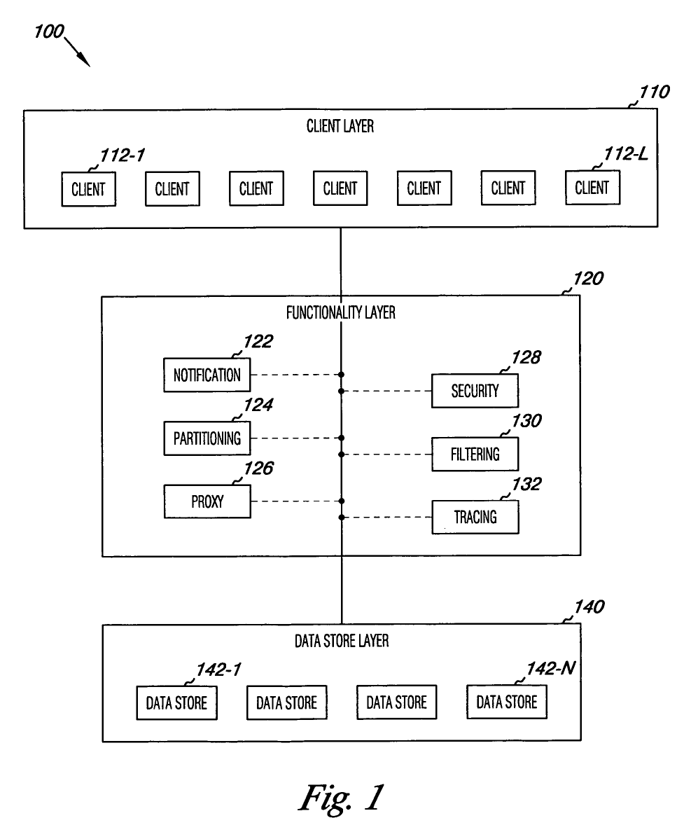

FIG. 1 is a block diagram of a computing system embodiment. In the embodiment illustrated in FIG. 1, the computing system 100 includes a client layer 110, a functionality layer 120, and a data store layer 140.

In some embodiments, such as that shown in FIG. 1, a client layer can be used to receive client instructions to be accomplished. However, a client layer may not be used in some embodiments. Further, the capabilities of a client layer, and other such layers, can be provided by another layer of a computing system, or by a computing system without the use of layer.

The receiving of a client instruction can be accomplished in a number of ways. For example, the handling of the receipt of a client instruction can be provided by one or more APIs. In some embodiments, client instructions can be received from clients using different messaging formats. Embodiments of the present disclosure can be designed to handle the receipt of such multiple message format types as discussed in more detail herein.

The Use of a Client Layer

Computer executable instructions can be used to provide the client layer 110. In the embodiment of FIG. 1, the client layer 110 is used to receive client instructions from a client. Clients are network devices that complete a variety of tasks on the network. Clients can include servers, desktop and laptop computing devices, peripherals, and other such devices that make use of the network. In the telecommunications field, clients can be used to provide services to the network, and/or to the users of the network.

For example, network services can include accounting, authorization, authentication, signal connection and/or routing, user information management, etc. User services, examples include, voice calling features (e.g., call waiting, caller id, voice messaging, etc), multimedia features (e.g., communication of voice and/or data, such as pictures, text, music, etc), short messaging service (SMS), and other such services involved in the communication of information.

With respect to the present disclosure, a client can initiate a request for a client instruction to be accomplished and can forward the request via computer executable instructions to the computing system 100. The client layer 110 receives the request. FIG. 1 illustrates that client requests 112-1 through 112-L can be received from a number of clients.

In some embodiments, the client instruction can be interpreted to select a number of functionality modules. This interpretation can include, for example, identifying an application format for the client instruction and matching the application format to a corresponding functionality module configuration. The application format information can be provided in a header of the request, or by other such information as discussed in more detail herein.

The number of clients can be operating using a similar or the same messaging format, but often, the clients using the network can be operating using a number of different messaging formats. For example, the client layer can be designed to receive a number of client instructions in different messaging formats, such as JMS, RPC, Tuxedo, and CORBA formats, as discussed above, among others.

By being capable of receiving and interpreting instructions in such various messaging formats, the functionalities provided by the computing system 100 do not have to be duplicated or replicated with respect to being utilized by the variety of different messaging formats. Additionally, through use of a chaining concept, the functionalities that can be provided can be specialized to the various messaging formats.

This also allows for the functionalities to be changed or the chaining of the functionalities to be changed without having to make changes to the application programs that are making the client instruction requests on the clients. For example, if the chaining process, and/or other processes involved in accomplishing the client instruction are provided in a single API, then the implementation of the API can be changed without affecting the client instruction request on the computing system 100.

The Functionality Layer

The embodiment of FIG. 1 also utilizes a functionality layer 120 to provide a number of functionalities (e.g., 122-132) to accomplish the client instructions received by the computing system 100 (e.g., via the client layer 110). In the embodiment illustrated in FIG. 1, a number of functionality modules are illustrated.

In accomplishing the client instructions, the functionality layer can configure a number of functionality modules that can be provided by one or more APIs. Configuring a number of functionality modules to form a functionality chain for use in accomplishing the client instruction can include the selection of the number of functionality modules to be chained together. The selection can be made in a predetermined manner, in which the modules making up a particular chain have already been selected.

Additionally, in such embodiments, a computing device or system can include a number of functionality module configurations with the modules forming a module chain already selected. These functionality module configurations can be lists of modules to be chained or actual chains of the modules, for example. When actual chains are provided, the configuring of the chain is the retrieving of the chains for use in accomplishing the client instructions. The selection can also be accomplished in an active manner, in some embodiments, in which, when a client instruction is received, the selection is made based upon the client instruction or the information contained therein.

Examples of functionality modules that can be employed by the computing system of FIG. 1 include, but are not limited to, notification 122, partitioning 124, proxy 126, security 128, filtering 130, and tracing 132. Those skilled in the art will understand that other network functionalities can also be provided or substituted for the functionalities illustrated in FIG. 1.

Computer executable instructions can be used to select which of the number of functionalities are to be utilized. The determination can be made, for example, based upon the particular client requesting the functionalities, the type of client, and/or other suitable criteria.

Further, these determinations can be made in real time, or can be pre-determined. For example, the functionality layer 120 can include computer executable instructions that identify which of a number of predetermined functionality module configurations to use. In some embodiments, these predetermined functionality module configurations can be stored in one or more of the data stores in data store layer 140.

The identification can be made in various manners. For example, information can be attached to a client instruction (e.g., within a header). The format of the instruction can also provide the identification of the message type, for example.

Computer executable instructions can be used to form a number of the functionality modules into a functionality chain. In various embodiments, a number of functionality modules can be chained together in series. However, the functionality modules can also be chained together in parallel, and in some embodiments, the modules can be chained together using both parallel and series chaining structures.

The notification functionality module 122 can be used, for example, to notify one or more of the clients that a change has been made to one of the functionality modules. The notification functionality module 122 can also be used to inform one or more of the clients that a change has been made to the chaining structure used with respect to the particular client.

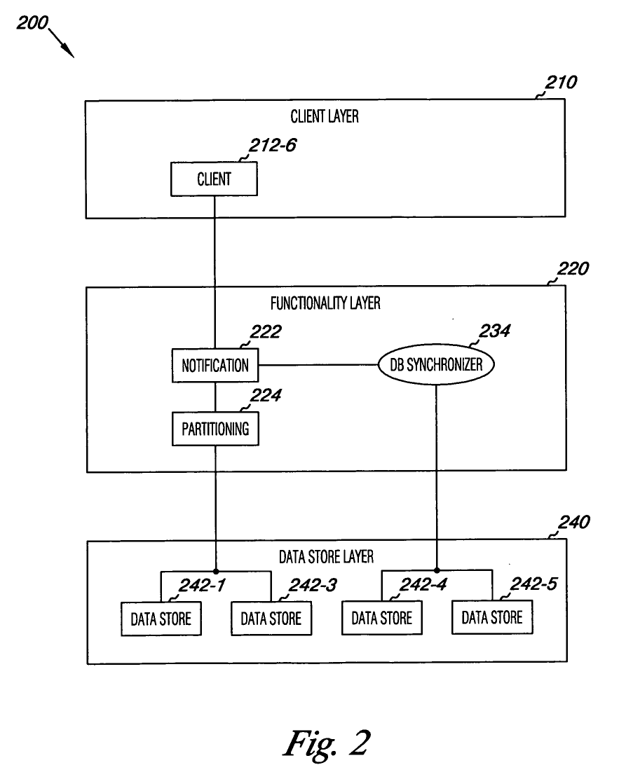

Further, in some embodiments, a notification module 122 can be used to notify other functionality modules within the computing system in order for changes to be made, for example, to data within the data stores. Such an embodiment is described in more detail below with respect to FIG. 2.

The partitioning functionality module 124 can be used to access data that has been partitioned into a number of data files and/or into a number of data stores. For example, since memory can sometimes not be available in sufficient amounts on one computing device to allow for storage of an entire set of data, the data set may be partitioned and stored in multiple data stores. However, if the data has been partitioned, it can be difficult to locate without a partitioning component that keeps track of the locations of the data.

In some embodiments, it may also be the case that, in order to accomplish a client instruction, similar types of data have to be accessed from a number of computing devices (e.g., client information data from computing devices having different software formats). In such instances, the partitioning module can be designed to track the locations of this information on the various computing devices.

A proxy functionality module 126 can be used to request that a particular task be accomplished on another computing device. Such functionality can be helpful in reducing the workload on a particular computing device and for balancing the workload among a number of computing devices within a computing system. Further, the proxy functionality module 126 can be used to select a computing device that can better handle the particular task, than the computing device on which the functionality layer is being provided.

A security functionality module 128 can be used to restrict the access to authorized client requests. In various embodiments, the security functionality module 128 can restrict access to the functionalities and/or the data stores.

The filtering functionality module 130 can be used in a similar manner to that of the security functionality module 128. In various embodiments, the filtering functionality module 130 can be used to restrict access to certain data stores, to certain data files within a data store, and/or to certain data within a data file, etc.

A tracing functionality module 132 can be used, for example, as a debugging tool. The tracing functionality module 132 can trace the progress of an application program, application program interface, other computer executable instruction or set of instructions to identify a problem in its execution, etc. The tracing information can then be used to help identify the problem in the executable instruction or instructions.

The Data Store Layer

As illustrated in FIG. 1, embodiments can also include a data store layer 140. The data store layer 140 can include a number of data stores 142-1 through 142-N that can be located on one or more computing devices within a computing system 100. The data stores are memory locations that have data (e.g., typically in data files) stored therein that can be accessed for use in accomplishing a client instruction. The data can be accessed by the various functionality modules used to accomplish the client instruction. In some embodiments, information in the data stores can be provided to the client in order to accomplish the client instruction.

Accessing data, for use by the number of functionality modules, from a number of data stores can be provided by one or more APIs. Accessing a number of data stores to obtain data for use by the number of functionality modules can include accessing a number of data stores on a number of different computing devices. For instance, the data stores can be located on different types of computing devices that may have different computing device software formats. For example, computing systems can be designed to access data from computing devices having data stores in Oracle, MySQL, Enscribe, LDAP, SQL/MX, and Times Ten formats, to name a few.

As noted above, the retrieving, configuring, and accessing process discussed above can be achieved through use of computer executable instructions designed to accomplish one or more of these tasks. For example, one or more APIs can be designed to handle one or more of these processes and, in some embodiments, these processes can be provided by a single application program interface.

Examples of the Use of Functionality Chaining

FIG. 2 illustrates an example of the embodiment of FIG. 1 configured for a particular set of functionalities. In the embodiment illustrated in FIG. 2, the client layer receives a client instruction from a particular client 212-6.

Computer executable instructions within the computing system 200 identify which functionality module configuration is to be used and form the functionality module configuration by chaining a number of modules together. The chaining process can be, for example, a set of computer executable instructions that use the functionality modules in a particular sequence, among other such methods. In the embodiment illustrated, the functionality module configuration arranges the notification module 222 and the partitioning module 224 in series and also arranges a database synchronizer module 234 in parallel with the partitioning module 224.

In this example, a change is being made to some information located in the data stores. In the embodiment shown, the information has been partitioned and, as such, the partitioning module 224 is being used to locate and administrate the changes to the information within data stores 242-1 and 242-3.

A notification module 222 is also being used and, in this embodiment, it is being used with a database synchronizer 234. The notification module 222 notifies the database synchronizer of the change being made to the data in the data stores 242-1 and 242-3. The database synchronizer 234 is used to make similar changes to the data in data stores 242-4 and 242-5.

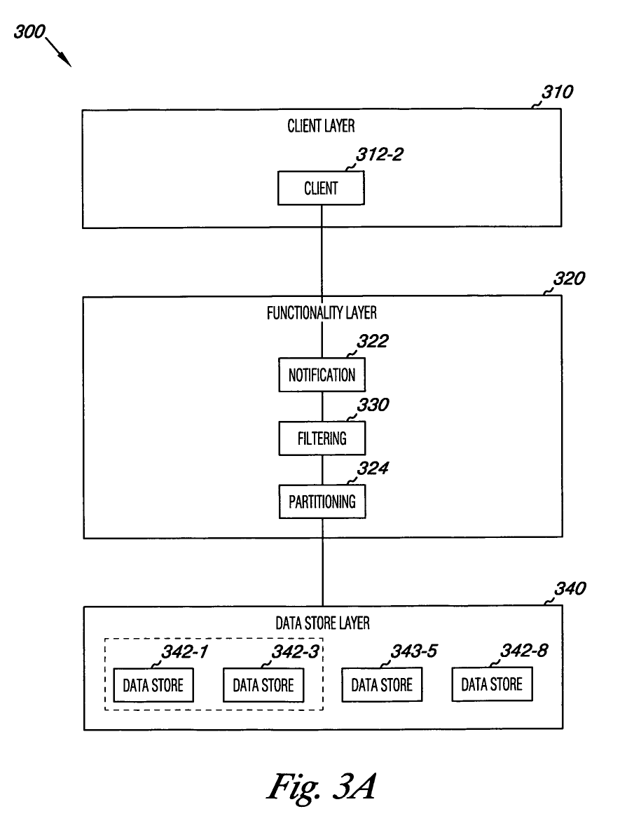

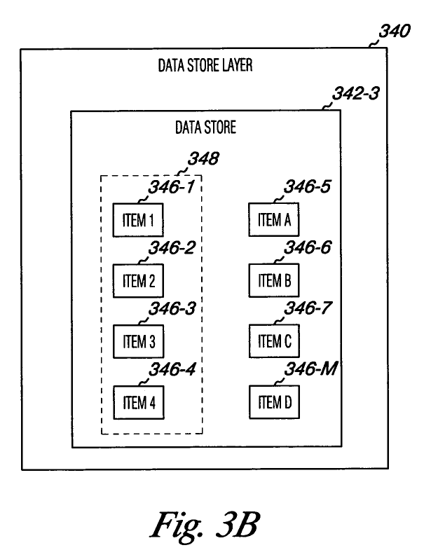

FIG. 3A illustrates an example of the embodiment of FIG. 1 configured for another particular set of functionalities. In the embodiment illustrated in FIG. 3A, the client layer 310 receives a client instruction from a particular client 312-2.

As with the embodiment of FIG. 2, computer executable instructions within the computing system 300 can identify which functionality module configuration is to be used and form the functionality module configuration by chaining a number modules together. The selected functionality module configuration is illustrated in the functionality layer 320 in FIG. 3A.

In the embodiment illustrated, the functionality module configuration arranges the notification module 322, the filtering module 330, and the partitioning module 324 in series. In this embodiment, the filtering module 330 provides for the filtering of the data stores within the data store layer 340.

Specifically, for illustration purposes, the filtering is indicated with the dashed box surrounding data stores 342-1 and 342-3. This dashed box indicates that access has been restricted, with respect to accomplishing the client instruction, to data stored within data stores 342-1 and 342-3. The order of the modules in series indicates that the filtering in this embodiment has been done prior to the use of the partitioning module 324 and, therefore, the partitioning module 324 has restricted access to the data stores in the data store layer 340.

In this example, a change is being made to some information located in the data stores. In the embodiment shown, the information has been partitioned and, as such, the partitioning module 324 is being used to locate and administrate the changes to the information within data stores 342-1 and 342-3.

FIG. 3B illustrates an example of a partitioning functionality. This figure illustrates another way in which a filtering module, such as module 330 in FIG. 3A, can be used to restrict access to data. In this embodiment, a number of items are stored within data store 342-3 in data store layer 340. Also, in this embodiment, a filtering module has restricted access (e.g., as indicated by the dashed box 348) to items 346-1, 346-2, 346-3, and 346-4. In accomplishing the client instruction, the computing system in this embodiment does not have access to 346-5, 346-6, 346-7, or 346-M.

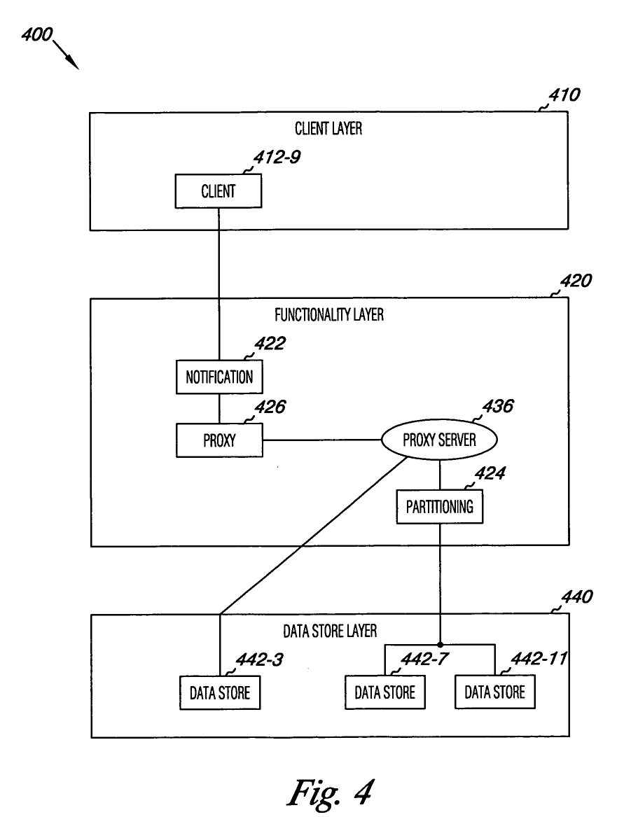

FIG. 4 illustrates an example of the embodiment of FIG. 1 configured for another particular set of functionalities. In the embodiment illustrated in FIG. 4, the client layer 410 receives a client instruction from a particular client 412-9.

Again, as with the embodiment of FIG. 2, computer executable instructions within the computing system 400 identify which functionality module configuration is to be used and form the functionality module configuration by chaining a number of modules together. In the embodiment illustrated, the functionality module configuration arranges the notification module 422, a proxy module 426, and a partitioning module 424 in series.

In this embodiment, a proxy module is being used to implement the partitioning functionality on another device (e.g., proxy server 436). Additionally, the proxy server 436 is accessing data in data store 442-3 directly, while also using a partitioning module 424 to identify data within data stores 442-7 and 442-11 of data store layer 440.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device, comprising:
a client layer to receive a client instruction from at least one of a number of clients;
a functionality layer having an application program interface (API) to interpret the client instruction and to configure a number of functionality modules to form a functionality chain for use in accomplishing the client instruction; and
a data store layer to store data for use by the number of functionality modules.

2. The device of claim 1, wherein at least some of the number of functionality modules are chained together in series.

3. The device of claim 1, wherein at least some of the number of functionality modules are chained together in parallel.

4. The device of claim 1, wherein at least one of the number of functionality modules is used multiple times in forming the functionality chain.

5. The device of claim 1, wherein the API includes a number of functionality module configurations for forming the functionality chain.

6. The device of claim 5, wherein the API includes instructions to identify a particular functionality module configuration to utilize and includes instructions to initiate functionality modules in accordance with the particular functionality module configuration.

7. A method for configurable functionality chaining, comprising:
receiving a client instruction from at least one of a number of clients;
selecting a number of functionality modules to form a functionality chain for use in accomplishing the client instruction; and
accessing a number of data stores to obtain data for use by the number of functionality modules.

8. The method of claim 7, wherein receiving a client instruction from the at least one of the number of clients includes receiving a number of client instructions in different messaging formats.

9. The method of claim 8, wherein receiving a number of client instructions in different messaging formats includes messaging formats selected from the group including;
JMS;
RPC;
Tuxedo; and
CORBA formats.

10. The method of claim 7, wherein accessing a number of data stores to obtain data for use by the number of functionality modules includes accessing a number of data stores on a number of different computing devices.

11. The method of claim 10, wherein accessing a number of data stores on different computing devices includes accessing data stores provided in a number of different computing device software formats selected from the group including;
Oracle;
MySQL;
Enscribe;
LDAP;
SQL/MX; and
Times Ten formats.

12. The method of claim 7, wherein the method is provided by a single application program interface.

13. A method for configurable functionality chaining, comprising:
receiving a client instruction from at least one of a number of clients;
interpreting the client instruction to select a number of functionality modules to configure a functionality chain for use in accomplishing the client instruction; and
accessing a number of data stores to obtain data for use by the number of functionality modules.

14. The method of claim 13, wherein interpreting the client instruction to select a number of functionality modules includes identifying an application format for the client instruction and matching the application format to a corresponding functionality module configuration.

15. The method of claim 13, wherein interpreting the client instruction to select a number of functionality modules to form a functionality chain for use in accomplishing the client instruction includes selecting the number of functionality modules from the group including;
notification of change;
partitioning;
proxy;
tracing;
security; and
filtering.

16. The method of claim 15, wherein the notification of change can notify one or more clients of a change made to the functionality chain.

17. The method of claim 15, wherein the notification of change can notify one or more clients of a change made to one of the number of functionality modules.

18. The method of claim 15, wherein filtering provides for restricting access to a number of particular data stores of the number of data stores.

19. The method of claim 15, wherein filtering provides for restricting access to particular data within a particular data store of the number of data stores.

20. A computing system, comprising:
a number of computing devices, each having access to a number of functionality modules for accomplishing a client instruction; and
a computing device, including:
means for receiving a client instruction from at least one of a number of clients;
means for selecting a number of functionality modules to form a functionality chain for use in accomplishing the client instruction; and
means for accessing data, for use by the number of functionality modules, from a number of data stores.

21. The system of claim 20, wherein the means for receiving a client instruction is provided by an application program interface.

22. The system of claim 20, wherein the means for selecting a number of functionality modules is provided by an application program interface.

23. The system of claim 20, wherein the means for accessing data, for use by the number of functionality modules, from a number of data stores, is provided by an application program interface.

24. The system of claim 20, wherein the means for receiving a client instruction from the at least one of the number of clients and the means for selecting a number of functionality modules to form a functionality chain for use in accomplishing the client instruction are provided by a single application program interface.

25. A computer readable medium having instructions executable for causing a device to perform a method, comprising:
receiving a client instruction from at least one of a number of clients;
selecting a number of functionality modules to form a functionality chain for use in accomplishing the client instruction; and
accessing a number of data stores to obtain data for use by the number of functionality modules.
